(19) United States
(12) Patent Application Publication
(10) Pub. No.: US 2012/0198363 A1
(43) Pub. Date: Aug. 2, 2012

(54) Web Development System and Methodology

(75) Inventor: Norman Douglas Blinston, JR., Queen Creek, AZ (US)

(73) Assignee: WELLS FARGO BANK, Charlotte, NC (US)

(21) Appl. No.: 13/016,508

(22) Filed: Jan. 28, 2011

(51) Int. Cl. G06F 3/048

(52) U.S. Cl. 715/762

(57) ABSTRACT

Systems and corresponding methodologies that provide for dynamic generation of Web application and pages is provided. The innovation discloses a task-specific action-based paradigm that enables dynamic generation of these applications and pages. The innovation encapsulates logic such as business logic into task-specific actions. These actions can be stored within databases and retrieved therefrom on an as-needed basis. Once called, the actions can be executed and thereafter dynamically incorporated into a web page.

### BACKGROUND

Traditionally, website architectures have been separated into two main components, a Portal Application and the action-specific Web application. Each of these components employs a specific function in the collection and rendering of information to an Internet user. The Portal application facilitates login, content management and data access (e.g., authentication and authorization).

In conventional systems, the Web application facilitates product-specific pieces of business logic, UI (user interface) presentation and interactions with other applications. Unfortunately, this tradition system is not very effective or efficient.

In accordance with traditional Web architectures, in a conventional multi-function business environment, every time a user desires to do something specific to a business unit, an action-specific Web application must be created. By creating action-specific Web applications, a programmer must organize all the unit-specific set up, generate a unit-specific UI, and program everything around this infrastructure. In other words, a large amount of coding is required, which is very expensive and time consuming to the organization.

For example, a business unit can often have hundreds of Web applications necessary to perform the day-to-day functions of a particular workflow. Every time a Web application is created, an all-encompassing environment related to it must also be created. Clearly, as businesses grow in scope, this traditional model of action-specific Web applications becomes more and more cumbersome, inefficient and therefore, expensive to manage.

### SUMMARY

The following presents a simplified summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

The innovation disclosed and claimed herein, in one aspect thereof, comprises a system that detaches the action from the tradition Web application paradigm. In other words, the innovation described and claimed herein deviates and distinguishes from the convention model of monolithic action-specific Web applications. Rather, the innovation discloses an architecture that employs a variety of “actions” that enable generation of an appropriate web page based upon a subset of those actions.

In one aspect, a generic-like site can be employed that renders a link whereby a user can define or identify what type or types of actions they desire to access. Thereafter, a set of actions can be performed. An appropriate Web page can be created and sent back to the browser for the user to continue performing their desired task(s).

In aspects, actions can be organized in lists. Thus, to enable performance of a certain function, one would have a list that would contain several different actions, then each action could be executed in sequence or parallel depending on parameters that are set up. Results can be returned back to the main controller of the list that is capable of executing these actions one at a time. Thus, Web applications can be created through the actions so specific Web pages need not be preset.

To the accomplishment of the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

FIG. 1 illustrates an example block diagram of a system that facilitates dynamic generation of Web applications and pages.

FIG. 2 illustrates an alternate block diagram of a system that facilitates task-specific Web application and page generation.

FIG. 3 illustrates an example schematic diagram of a customer sequence in accordance with aspects of the innovation.

FIG. 4 illustrates an example flow chart of procedures that facilitate calling task-specific home page actions in accordance with an aspect of the innovation.

FIG. 5 illustrates an example flow chart of procedures that facilitate user-specific page generation in accordance with an aspect of the innovation.

FIG. 6 illustrates an example flow chart of procedures that facilitate calling task-specific service actions in accordance with an aspect of the innovation.

FIG. 7 illustrates an example schematic diagram of an action executable sequence in accordance with aspects of the innovation.

FIG. 8 illustrates an example schematic diagram of an authentication sequence in accordance with aspects of the innovation.

FIG. 9 illustrates a block diagram of a computer operable to execute the disclosed architecture.

FIG. 10 illustrates a schematic block diagram of an exemplary computing environment in accordance with the subject innovation.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details. In other instances, well-known structures and devices are shown in block diagram form in order to facilitate describing the innovation.

As used in this application, the terms “component” and “system” are intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

As used herein, the term to “infer” or “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

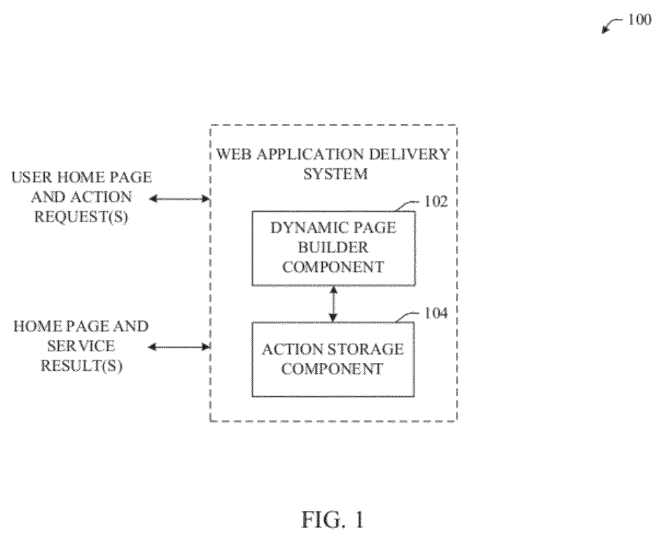

Referring initially to the drawings, FIG. 1 illustrates an example block diagram of a web application delivery system 100 in accordance with aspects of the innovation. Generally, the system 100 can include a dynamic page builder component 102 and an action storage component 104 that together are capable of employing task-specific actions to streamline the processes involved in generating web applications. In other words, the innovation distinguishes from conventional paradigms in that it employs the dynamic page builder component 102 which calls at least one task-specific action (e.g., via action storage component 104) to dynamically build and deliver a web application.

As described above, conventionally, every time a user wants to do something via the Web, e.g., for the business unit, it is necessary to pre-program or create what is often referred to as a “task-specific” web application. In other words, a programmer has to gather all the set up, all the UI (user interface) configurations and parameters, and program everything specific to the task. It will be understood that this process can be extremely time consuming and costly for a business unit having a large number of task-specific action.

In one example, it is not uncommon for a business unit to have hundreds of client- and task-specific web applications. Every time a web application is created, it is necessary to have the specific application environment that corresponds to it.

The innovation distinguishes from the conventional all-encompassing paradigm and employs an architecture that dynamically builds web applications based upon task-specific actions, rather than requiring creation of a separate complete web application for every individual task (or action). In other words, the innovation can gather (or call) a variety of task-specific actions and dynamically incorporate them into a task-specific web application. The figures that follow illustrate examples of component interactions that facilitate this dynamic web application generation.

In accordance with the innovation, a user can visit a website (e.g., URL (uniform resource locator), having a link (e.g., hyperlink) and, based upon a desired task, an action or set of actions can be called specific to the desired task. Thereafter, an appropriate web page (tailored to the action(s)) can be created (e.g., via the dynamic page builder component 102) and sent back to the browser in the form of a task-specific web application for the user to continue with the desired task. Actions can be stored separately or in lists (e.g., via action storage component 104), for example, to perform a certain function, a user could have a list that includes several different actions. Each action can be executed in sequence or parallel depending on parameters that are set up. Results can be returned back to a main controller of the action list that is responsible for executing these actions one at a time, or parallel if appropriate.

Essentially, in accordance with the innovation, web applications can be created through the task-specific actions. Thus, web pages or applications need not be preset or preprogrammed. Effectively, pieces get created based on what a user desires to do and what is appropriate to be placed on the UI for the user to see.

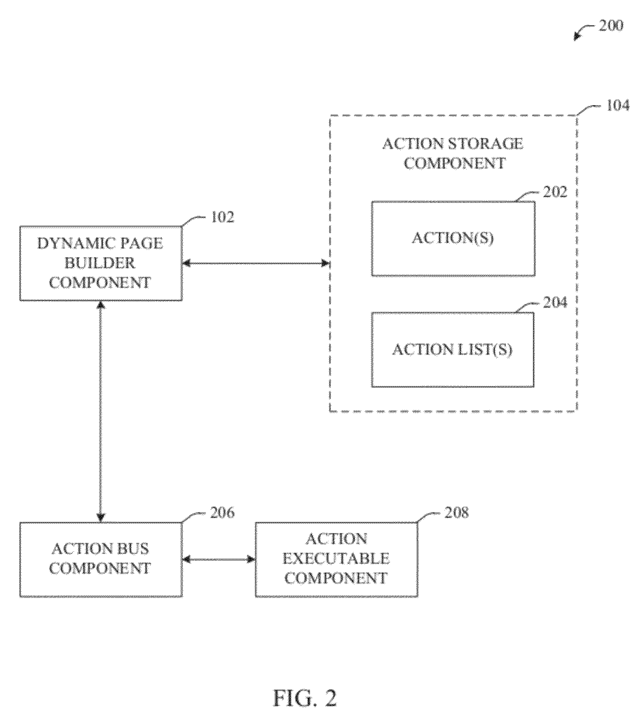

FIG. 2 illustrates an alternative block diagram of a web page development architecture 200 in accordance with aspects of the innovation. As shown, the system 200 can include a dynamic page builder component 102 that is configured to access actions from the action storage component 104. As illustrated, the actions can be stored individually (202), in lists (204) or as otherwise appropriate within action storage component 104.

In operation, the dynamic page builder component 102 can access the action storage component 104 to retrieve task-specific actions or action lists based upon a user's desired or appropriate workflow. Once retrieved, the actions or action lists can be placed upon an action bus component 206 which is capable of communicating with the action executable component 208. The action executable component 208 performs or implements the appropriate action, returns to the bus component 206 and ultimately back to the dynamic page builder component 102 where the web application is generated. It is to be understood that communication between each of the components (102, 104, 206, 208) can be bi-directional and implemented on an as-needed basis to execute actions, e.g., in series or parallel.

Following is a discussion of example sequence diagrams which further illustrate acts of the system which enable dynamic generation of web applications. While specific actions are shown and described, it is to be understood that other aspects can exist which include more or fewer acts as shown. Additionally, some acts can be implemented in alternative order without departing from the spirit and/or scope of the innovation and claims appended hereto.

Essentially, the paradigm of system 200 can include four individual components, the page builder 102, action storage 104, action bus 206 and action executable components 208. As described supra, the page builder component 102 is an engine that receives requests and calls task-specific actions to produce a response. The action storage 104 is a component that stores actions and action lists for retrieval by the page builder 102. As illustrated in the schematics described infra, the action bus 206 is a component that carries action messages to/from the page builder (102) and the action executable (208) components. The action executable component 208 receives an action message(s) and runs code to complete an action.

As described above, the page builder 102, is one of the main pieces of the system 200. In particular, the component 102 can have at least the following responsibilities:

1. Receive requests from the web via HTTP methods (e.g. POST, GET, etc.);

2. Retrieve an action/action list for a request;

3. Parse the action;

4. Create an action message;

5. Put the action message on the Action Message Bus;

6. Receive action results and parse them;

7. Take action based on action results;

8. Create and send the response to the web request.

An action (or list of actions) can be defined having at least the following properties:

1. Parallel Flag—If yes, the action can be run in parallel with other actions;

2. Action Name—The name of the action used to call and execute it;

3. Action Type—The type of action, there can be at least three types:
a. Business (1)—this action performs business logic on the data provided and outputs the results;
b. List (2)—This action type indicates that the action is a list made up of other actions;
c. Page (3)—this action performs the acts necessary to include the output of an HTML page to the user;

4. Left Hand Side—Defines the inputs necessary for successful completion
a. Input Parameters—A list of parameters and data types for the parameters

5. Right Hand Side—Defines the outputs the action will return
a. Output Data—A list of the outputs and the data types for those outputs

With reference to the action storage 104, actions can be stored in a database or file and accessed via a database call or via a service. An action list is a collection of actions. The definition of an action list can include an Action List Name which is merely the name of the action list. Additionally, the definition can include a defined list of the actions that make up the list. In examples, the last action in the list may be of type “page” or of type “list.”

An action message is used to call the action. The message is defined using an Action Name which is merely the name of the action to call. The message also includes a plurality of Action Parameters which define the input parameters to each particular action.

In one aspect, the action message is a simple XML message defined (at a high level) as follows:

```
<ActionMessage>
      <Requestor>**Requestor name used for routing the action
      response**</Requestor>
      <RequestID>**ID for the request**</RequestID>
      <ActionName>**Text**</ActionName>
      <Parameters>
            <Parameter>
                  <ParamName>**Name of the parameter**
                  </ParamName>
                  <ParamData>**Parameter Data**</ParamData>
            </Parameter> <!-This repeats for each parameter ->
      </Parameters>
</ActionMessage>
```

In operation, an action message is placed on an action message bus 206 where it is routed to the code that implements the action. The routing takes placed based at least upon the action name. The bus 206 is responsible for finding the appropriate action executable 208 to route the message. The requestor of the message (page builder 102) need not know where the executable resides. With regard to action implementation, an action is implemented code that is executed when the action message arrives at its destination. The implementation can be in most any programming language. In operation, the implementation includes an ability to receive a request via the action message bus. Additionally, the implementation, includes an ability to act on the request, to formulate a response to the request, and to place the response on the action message bus 206.

As illustrated in detail infra, an action response is created once the action has been executed. The action response can contain an action name, action outputs, or action errors. The action response can be a simple XML message defined (at a high level) as follows:

```
<ActionResponse>
      <Requestor>**Requestor name to route the response back to the
requestor**</Requestor>
      <RequestID>**ID for the request**</RequestID>
      <ActionName>**Text**</ActionName>
      <Outputs>
            <Output>
                  <OutputName>**Name of the output**
                  </OutputName>
                  </OutputData>**Output Data**</OutputData>
            </Output> <!-This repeats for each output ->
      </Outputs>
</ActionResponse>
```

Overall, the innovation provides a new paradigm based upon actions whereby separate all-encompassing web applications are not needed. Each action is a set of steps (or acts) to take in order to fulfill a request—including dynamic page creation. In accordance with the innovation, there need not be separate web applications for specific groups. Rather, business logic and the like can be encapsulated into actions and dynamically executed via a page builder component. Systems of record (SOR) or databases (or stores) can be used to assist with business logic. The innovation employs a dynamic user interface (UI) that is capable of adapting based upon particular actions on an as-needed basis. In operation, the innovation employs the SOR for data while the actions create look and feel of the web application.

Each action is an atomic operation. As well, an action can be an action list as described in more detail infra. In operation, actions are interpreted dynamically and can be stored in a database or in a file. Moreover, actions can be executed singularly or in parallel as appropriate.

An Action list is a collection of actions which can be executed in sequential order. Alternatively, actions can run in parallel so long as one of the actions is not a “singular” action, which must complete before the next action in the list is executed.

In accordance with the dynamic user interface, web pages are built via an action(s). In doing so, action outputs from previous actions in an action list can be used as inputs to the page. As described above, an action SOR stores actions. The SOR can also store other service specific data used to fulfill services based on product.

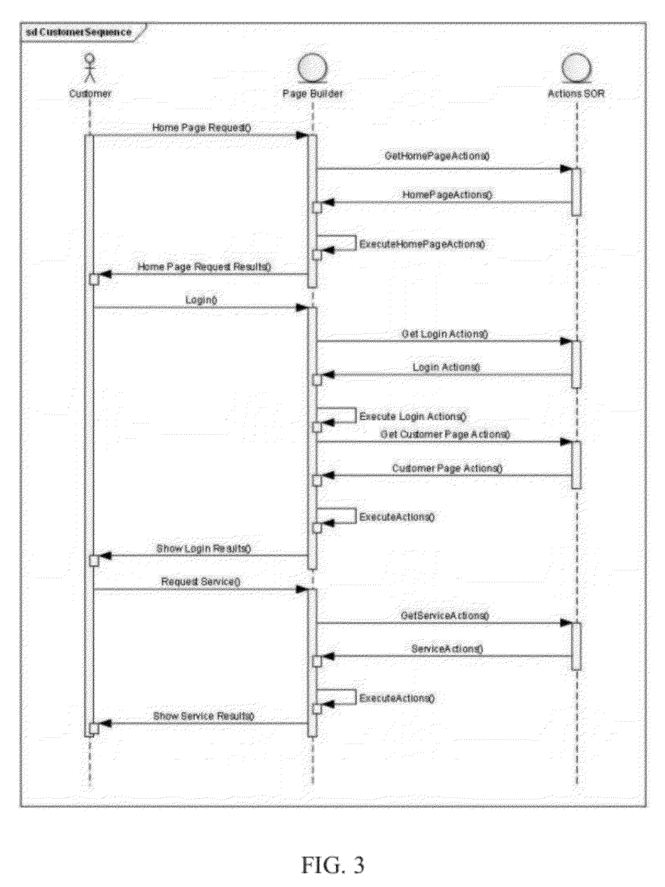

With reference now to FIG. 3, an example sequence diagram is shown. Starting at the top of the diagram, a login sequence is shown. Here, the customer (or user) generates a home page request. In operation of one example, the customer types in their browser and clicks on a link to go to a homepage. The page builder (e.g., dynamic page builder component 102 of FIG. 1) receives the request and determines a home page action list, for example, based upon a user's login credentials.

As shown, home page actions are returned for generation of a home page. One of the returned actions is that which effects generation of the home page itself. Another could be an action that identifies certain home page announcements, stories, etc., for instance. Other actions can provide links to log in so that the user can do other things, e.g., post stories, videos, etc., from a home page standpoint.

Continuing with the schematic, when a user clicks on login, there can be a set of login actions accessed, returned and executed. For example, one action can be executed to prompt or trigger integration of the login page. The system progresses through the actions of creating the login page thereby rendering the login page to the user.

In this example, the first action is to validate the user, e.g., via username and password credentials. The system can then call an action to validate a user by passing in the user credentials, username or password. In operation, the action gets put on the action bus, and pushed to the executable. Thereafter, the validation action of logging in or validating the user occurs in that executable. Based on the results, pass or fail, a result message can be created and returned. As a function of the result, an appropriate web page can be generated. If the validation is successful, the system can create a user home page. In doing so, the system creates the user home page and renders the page to the user.

On the user-specific home page, there can be links to actions that a user is authorized to do. Thus, when building that page, the system requests specific services (or functionalities) that correspond with the particular user and corresponding credentials. Once identified, links to that functionality can be embedded or rendered onto the home page.

In a specific financial services example, suppose a user can perform stop payments for a certain account. Basically, from a stop payment standpoint it is important to enter a certain date related to the stop which is facilitated by the specific service actions returned and executed. Here, the user can click on stop payments which generate a request for the stop payment service. In response, the page builder accesses the stop payments action page. The system would then render the actions that would create a stop payments page, including the data that is needed to effect the stop payment, e.g., account information, date.

Once the page is created, it is returned to the UI and rendered to the user. The user employs the UI to fill out the form e.g., indicating a particular deposit account that payments cannot be accepted from or the amounts over a particular threshold which cannot be accepted.

In operation, the data is returned, e.g., the account that it applies to, what accounts it cannot receive from and what dollar amount it has to be under. Once received, the page builder requests the appropriate stop payment actions again. The first action identifies the account and what is to be validated against that account. In other words, the page builder would place an account validation action the bus, passing in the account number, etc. In return, a validation of the account is received.

Continuing with the example, the next step is to apply payment stops—whereby, the account, the data, which accounts cannot be accepted from and maximum dollar amount information is passed into the next action. The action executes and automatically sets up the stop payment information on a system of records for that account. It is to be appreciated that this execution of actions is hidden to the page builder.

Thereafter, results are returned, e.g., the stop payment information is applied. The next step is to build the results page. In doing so, data is received that includes a list of accounts, the maximum dollar amounts, etc. A request is sent to the page builder to build the next appropriate web page. The builder generates the page, sends it back to the user and the user can then move on to another service, log out, etc. Essentially, in accordance with the innovation, each service can be expressed as a group or list of actions. In the aforementioned stop payment example, the actions included validate account, apply stops, build the page, etc. Thus, the last action in any list one one of two things—another action list or an instruction to build a page to be sent to the user.

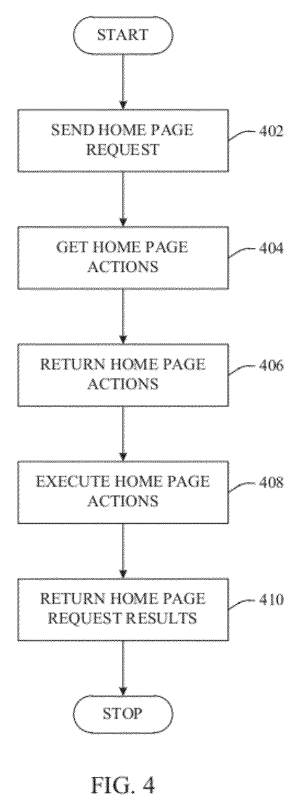

FIGS. 4-6 illustrate the example schematic of FIG. 3 as a methodology or series of acts in accordance with an aspect of the innovation. While, for purposes of simplicity of explanation, these methodologies shown herein, e.g., in the form of flow charts, are shown and described as a series of acts, it is to be understood and appreciated that the subject innovation is not limited by the order of acts, as some acts may, in accordance with the innovation, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

FIG. 4 describes example acts of the home page request sequence. At 402, a home page request is generated and sent, for example, to a page builder. Here, the home page request can be generated simply by a user entering, or clicking on, a web site. At 404, the page builder can be invoked and calls the appropriate actions for the home page which are returned to the page builder at 406. The actions are executed at 408 which prompt results to be returned at 410. The actions are used by the page builder and sent to the user.

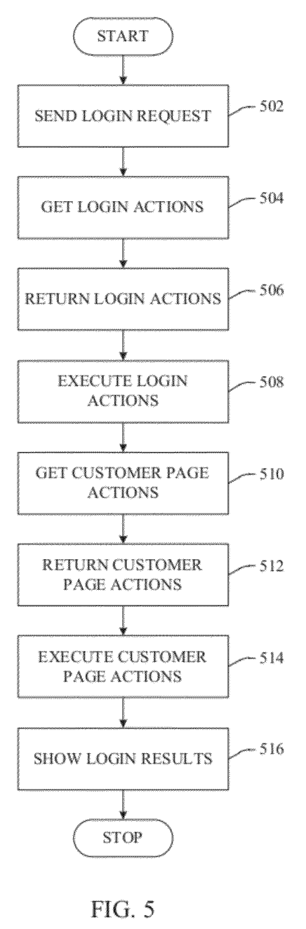

FIG. 5 illustrates an example methodology of a login sequence in accordance with aspects of the innovation. At 502, a login request is generated and sent. Here, a user can enter their credentials (e.g., username, password) and trigger a login sequence (e.g., via pressing “enter”). Login actions can be accessed, returned and executed at 504, 506 and 508 respectively. At 510, customer page actions are accessed and returned and executed at 512 and 514 respectively. The page builder employs the action results to render the login results to the user, at 516.

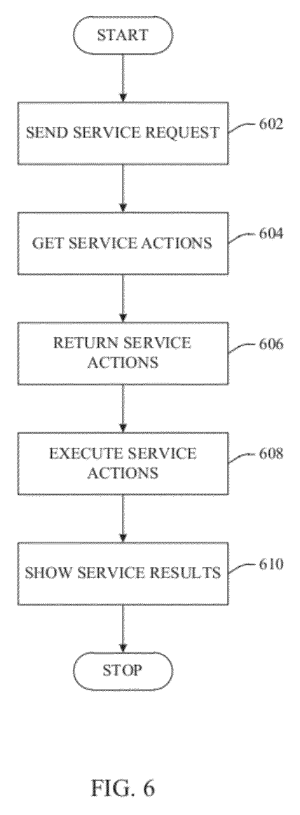

FIG. 6 illustrates an example methodology of implementing service actions in accordance with aspects of the innovation. At 602, a service request is triggered or otherwise generated. Once a user clicks on a service, appropriate actions can be called or accessed at 604. The service actions are returned to the page builder at 606, placed on the bus and executed at 608. The page builder employs the executed results and renders the service results to the user.

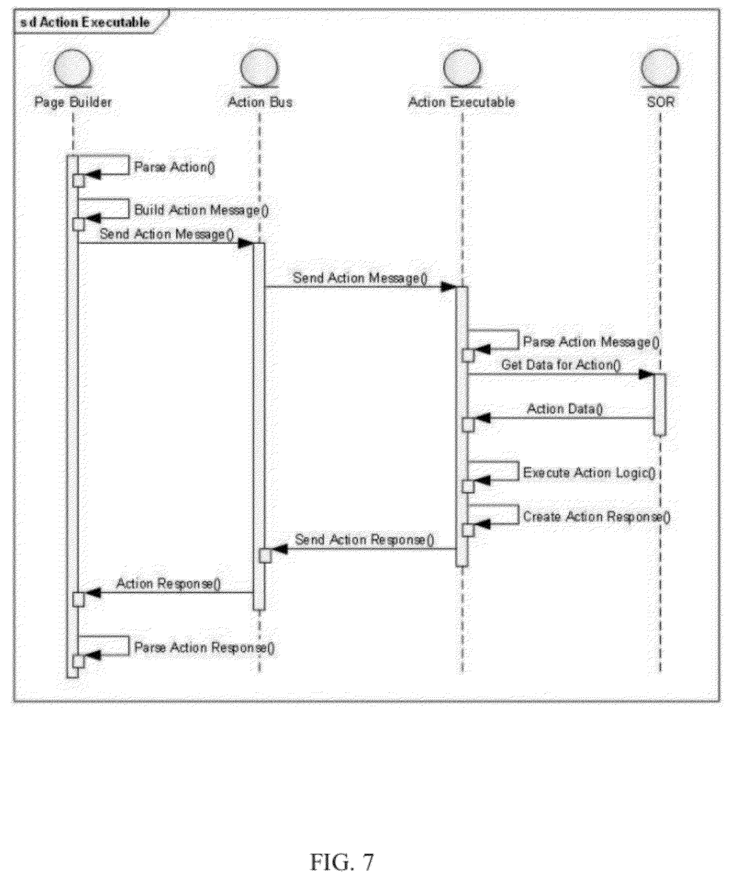

FIG. 7 illustrates an example schematic of the action executable phase of the innovation. As illustrated, FIG. 7 demonstrates interactions between a dynamic page builder component, an action bus component, an action executable component and the SOR (systems of record or databases). Once the action(s) is received by the page builder, it is parsed and an action message is built. Thereafter, the action message(s) is sent to the action bus and forwarded to the action executable component that parses the message(s). Data for the actions is obtained from the SOR and returned to the action executable component.

Next, the action logic is executed and an action response(s) created and sent back to the page builder via the action bus. Once at the dynamic page builder, the action response(s) are parsed and rendered to a user.

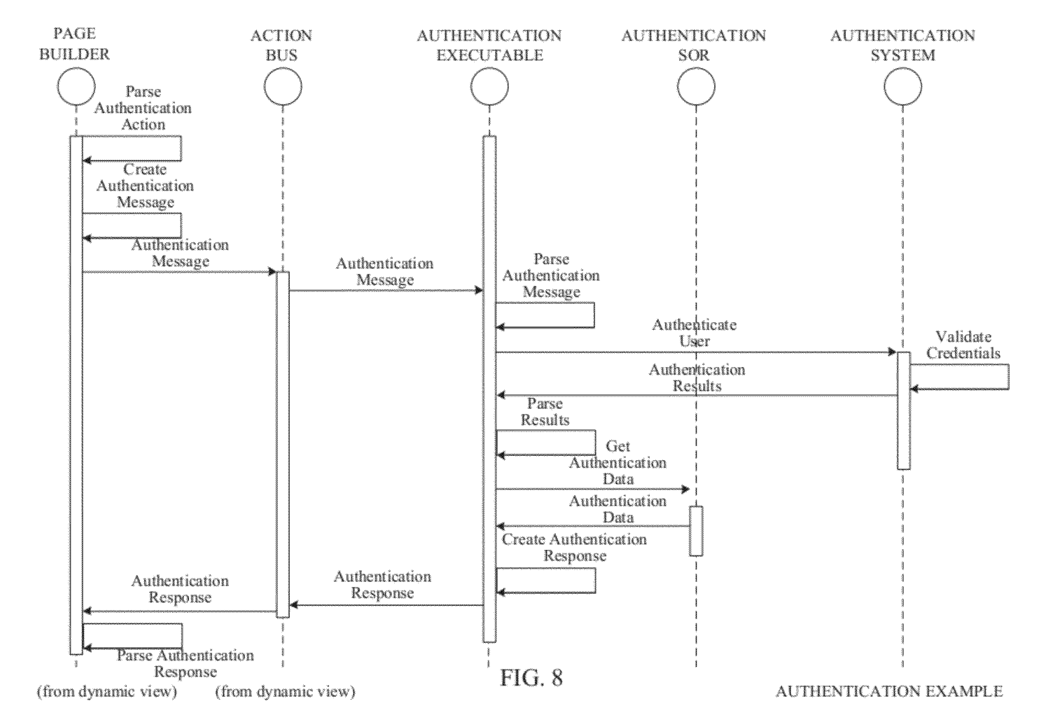

Similar to the schematic of FIG. 7, an example authentication schematic is illustrated in FIG. 8. The process begins with the page builder parsing the authentication action and creating the authentication message. The page builder sends the authentication message to the action bus which routes the authentication message to the authentication executable.

Similar to the previous example, the authentication executable parses the authentication message and sends the authentication credentials to the authentication system for validation. The Authentication System validates the credentials and sends the results to the authentication executable which parses the results.

Next, the authentication executable accesses relevant data from the authentication SOR. The authentication executable creates an authentication response and sends it to the action bus which routes the response to the Page Builder. Thereafter, the response is parsed by the page builder and rendered to the user as appropriate.

One of the main differences of the innovation from conventional web application is that, traditionally, when web applications are generated, the web pages themselves must be pre-generated or created. Contrary to this conventional paradigm, the innovation creates web pages dynamically. For instance, in the JAVA platform there are no JFP pages, there are no HTML pages, etc.—regardless of what they are called depending on a particular language. This is one difference between the innovation and conventional systems. In accordance with the innovation, rendering of web pages ends up being programmatically driven instead of having a template that attempts to fill in data from the page itself.

A second difference lies in the fact that traditional applications are isolated into their own units. Below is a discussion of a stop payment example for financial institutions. In the stop example, it will be appreciated that part of a system performs specific actions on accounts. For instance, in a conventional model, there can be a stops web application which would be separate from a reporting application, which would be separate from a lockbox image application. It will be appreciated that these are three separate actions running in separate environments. In conventional web applications, the stop, lockbox and reporting functionality is programmed into separate web applications. This is cumbersome and difficult to manage in the case of modifications. To the contrary, the subject innovation can dynamically employ separate actions and deliver content to a user on an as-needed or as-desired basis without a need to program a complete web application environment. In other words, to add additional functionality to a page, a programmer need not go through the traditional development lifecycle of adding in new functionality into a web application. Rather, actions can be called on-demand together with action-specific data from an appropriate SOR.

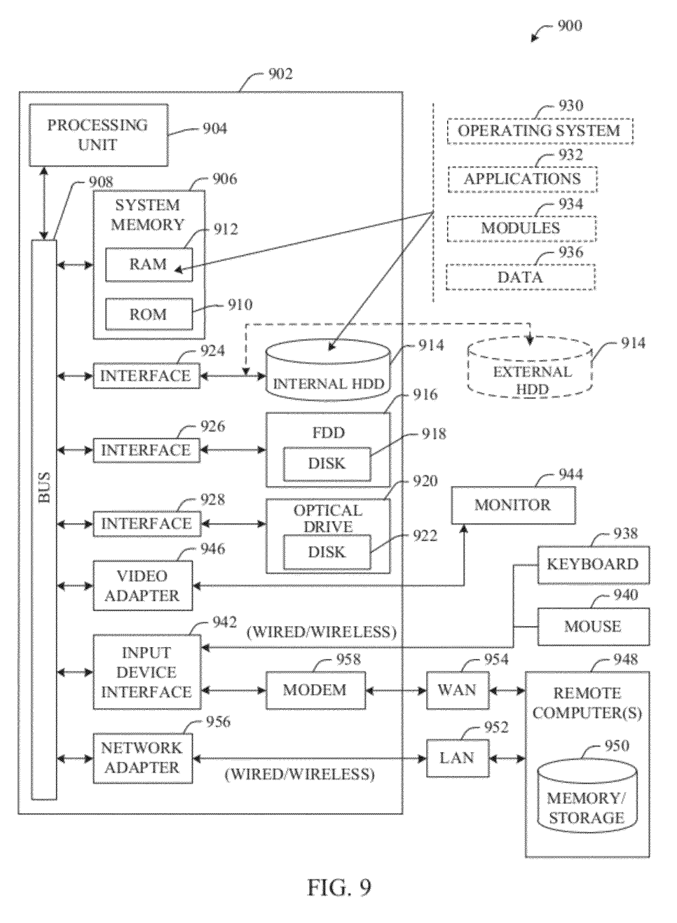

Referring now to FIG. 9, there is illustrated a block diagram of a computer operable to execute the disclosed architecture. In order to provide additional context for various aspects of the subject innovation, FIG. 9 and the following discussion are intended to provide a brief, general description of a suitable computing environment 900 in which the various aspects of the innovation can be implemented. While the innovation has been described above in the general context of computer-executable instructions that may run on one or more computers, those skilled in the art will recognize that the innovation also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 9, the exemplary environment 900 for implementing various aspects of the innovation includes a computer 902, the computer 902 including a processing unit 904, a system memory 906 and a system bus 908. The system bus 908 couples system components including, but not limited to, the system memory 906 to the processing unit 904. The processing unit 904 can be any of various commercially available processors. Dual microprocessors and other multi-processor architectures may also be employed as the processing unit 904.

The system bus 908 can be any of several types of bus structure that may further interconnect to a memory bus (with or without a memory controller), a peripheral bus, and a local bus using any of a variety of commercially available bus architectures. The system memory 906 includes read-only memory (ROM) 910 and random access memory (RAM) 912. A basic input/output system (BIOS) is stored in a non-volatile memory 910 such as ROM, EPROM, EEPROM, which BIOS contains the basic routines that help to transfer information between elements within the computer 902, such as during start-up. The RAM 912 can also include a high-speed RAM such as static RAM for caching data.

The computer 902 further includes an internal hard disk drive (HDD) 914 (e.g., EIDE, SATA), which internal hard disk drive 914 may also be configured for external use in a suitable chassis (not shown), a magnetic floppy disk drive (FDD) 916, (e.g., to read from or write to a removable diskette 918) and an optical disk drive 920, (e.g., reading a CD-ROM disk 922 or, to read from or write to other high capacity optical media such as the DVD). The hard disk drive 914, magnetic disk drive 916 and optical disk drive 920 can be connected to the system bus 908 by a hard disk drive interface 924, a magnetic disk drive interface 926 and an optical drive interface 928, respectively. The interface 924 for external drive implementations includes at least one or both of Universal Serial Bus (USB) and IEEE 1394 interface technologies. Other external drive connection technologies are within contemplation of the subject innovation.

The drives and their associated computer-readable media provide nonvolatile storage of data, data structures, computer-executable instructions, and so forth. For the computer 902, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the innovation.

A number of program modules can be stored in the drives and RAM 912, including an operating system 930, one or more application programs 932, other program modules 934 and program data 936. All or portions of the operating system, applications, modules, and/or data can also be cached in the RAM 912. It is appreciated that the innovation can be implemented with various commercially available operating systems or combinations of operating systems.

A user can enter commands and information into the computer 902 through one or more wired/wireless input devices, e.g., a keyboard 938 and a pointing device, such as a mouse 940. Other input devices (not shown) may include a microphone, an IR remote control, a joystick, a game pad, a stylus pen, touch screen, or the like. These and other input devices are often connected to the processing unit 904 through an input device interface 942 that is coupled to the system bus 908, but can be connected by other interfaces, such as a parallel port, an IEEE 1394 serial port, a game port, a USB port, an IR interface, etc.

A monitor 944 or other type of display device is also connected to the system bus 908 via an interface, such as a video adapter 946. In addition to the monitor 944, a computer typically includes other peripheral output devices (not shown), such as speakers, printers, etc.

The computer 902 may operate in a networked environment using logical connections via wired and/or wireless communications to one or more remote computers, such as a remote computer(s) 948. The remote computer(s) 948 can be a workstation, a server computer, a router, a personal computer, portable computer, microprocessor-based entertainment appliance, a peer device or other common network node, and typically includes many or all of the elements described relative to the computer 902, although, for purposes of brevity, only a memory/storage device 950 is illustrated. The logical connections depicted include wired/wireless connectivity to a local area network (LAN) 952 and/or larger networks, e.g., a wide area network (WAN) 954. Such LAN and WAN networking environments are commonplace in offices and companies, and facilitate enterprise-wide computer networks, such as intranets, all of which may connect to a global communications network, e.g., the Internet.

When used in a LAN networking environment, the computer 902 is connected to the local network 952 through a wired and/or wireless communication network interface or adapter 956. The adapter 956 may facilitate wired or wireless communication to the LAN 952, which may also include a wireless access point disposed thereon for communicating with the wireless adapter 956.

When used in a WAN networking environment, the computer 902 can include a modem 958, or is connected to a communications server on the WAN 954, or has other means for establishing communications over the WAN 954, such as by way of the Internet. The modem 958, which can be internal or external and a wired or wireless device, is connected to the system bus 908 via the serial port interface 942. In a networked environment, program modules depicted relative to the computer 902, or portions thereof, can be stored in the remote memory/storage device 950. It will be appreciated that the network connections shown are exemplary and other means of establishing a communications link between the computers can be used.

The computer 902 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

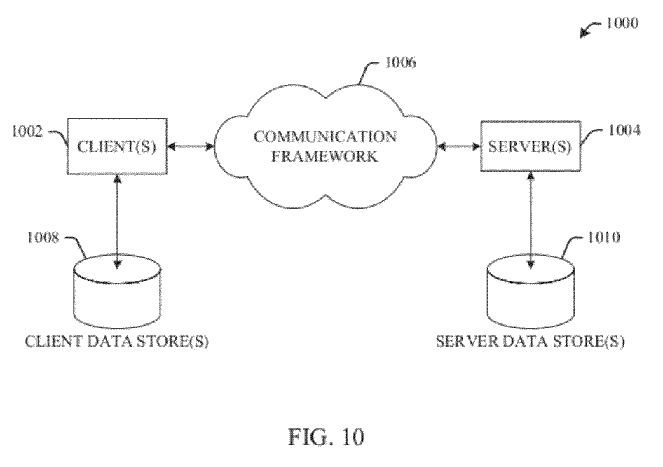

Referring now to FIG. 10, there is illustrated a schematic block diagram of an exemplary computing environment 1000 in accordance with the subject innovation. The system 1000 includes one or more client(s) 1002. The client(s) 1002 can be hardware and/or software (e.g., threads, processes, computing devices). The client(s) 1002 can house cookie(s) and/or associated contextual information by employing the innovation, for example.

The system 1000 also includes one or more server(s) 1004. The server(s) 1004 can also be hardware and/or software (e.g., threads, processes, computing devices). The servers 1004 can house threads to perform transformations by employing the innovation, for example. One possible communication between a client 1002 and a server 1004 can be in the form of a data packet adapted to be transmitted between two or more computer processes. The data packet may include a cookie and/or associated contextual information, for example. The system 1000 includes a communication framework 1006 (e.g., a global communication network such as the Internet) that can be employed to facilitate communications between the client(s) 1002 and the server(s) 1004.

Communications can be facilitated via a wired (including optical fiber) and/or wireless technology. The client(s) 1002 are operatively connected to one or more client data store(s) 1008 that can be employed to store information local to the client(s) 1002 (e.g., cookie(s) and/or associated contextual information). Similarly, the server(s) 1004 are operatively connected to one or more server data store(s) 1010 that can be employed to store information local to the servers 1004.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system that facilitates dynamic generation of a web application, comprising:
an action storage component that maintains a plurality of task-specific actions; and
a dynamic page builder component that calls and dynamically incorporates a result of at least one of the plurality of actions into the web application based upon a user input.

2. The system of claim 1, the plurality of task-specific actions includes individual actions or lists of actions.

3. The system of claim 2, wherein the lists of actions include serial actions.

4. The system of claim 2, wherein the lists of actions include parallel actions.

5. The system of claim 1, further comprising:
an action bus component that receives the at least one of the plurality of actions from the dynamic page builder component; and
an action executable component that receives the at least one of the plurality of actions from the action bus component, triggers computer-executable instructions that perform the at least one of the plurality of actions and routes a result of the at least one of the plurality of action to the dynamic page builder component via the action bus component for dynamic generation of a web page.

6. The system of claim 1, wherein the at least one of the plurality of actions is a home page action.

7. The system of claim 1, wherein the at least one of the plurality of actions is a login action.

8. The system of claim 1, wherein the at least one of the plurality of actions is a customer page action.

9. The system of claim 1, wherein the at least one of the plurality of actions is a service action.

10. A computer-implemented method of dynamic generation of a task-specific Web page, comprising:
employing a processor that executes computer executable instructions stored on a computer readable storage medium to implement the following acts:
receiving a user input;
calling a task-specific action from an action storage component based at least in part upon the user input;
executing the task-specific action; and
rendering the task-specific Web page based at least in part upon a result of the execution to the task-specific action.

11. The computer-implemented method of claim 10, wherein the action is a list of actions.

12. The computer-implemented method of claim 11, further comprising interpreting a flag that identifies parallel or serial processing of each of the list of actions.

13. The computer-implemented method of claim 10, further comprising placing the task-specific action upon an action bus that facilitates transmission between a plurality of system components.

14. The computer-implemented method of claim 10, wherein the action is one of a task-specific home page action, login action, or service action.

15. The computer-implemented method of claim 10, wherein the action is selected based at least in part upon user-specific credentials.

16. The computer-implemented method of claim 10, further comprising building a task-specific action message that facilitates the call of the task-specific action.

17. A computer-executable system, comprising:
computer-implemented means for identifying a task-specific action based upon a user input or credential;
computer-implemented means for calling the task-specific action;
computer-implemented means for executing the task-specific action; and
computer-implemented means for dynamically building a Web page based at least in part upon a result of the task-specific execution.

18. The computer-executable system of claim 17, wherein the task-specific action is a list of parallel-executable actions.

19. The computer-executable system of claim 17, wherein the task-specific action is a list of serially-executable actions.

20. The computer-executable system of claim 17, further comprising computer-implemented means for rendering the Web page to a user.
